(19) United States
(12) Patent Application Publication
(10) Pub. No.: US 2017/0153957 A1
(43) Pub. Date: Jun. 1, 2017

(54) METHOD FOR TESTING A COMPUTER SYSTEM WITH A BASIC INPUT/OUTPUT SYSTEM INTERFACE PROGRAM

(71) Applicants: Inventec (Pudong) Technology Corp., Shanghai (CN); Inventec Corporation, Taipei (TW)

(72) Inventors: Ta-Hua Lin, Taipei (TW); Ching-Chun Huang, Taipei (TW); Shih-Keng Tseng, Taipei (TW)

(21) Appl. No.: 15/083,299

(22) Filed: Mar. 29, 2016

(30) Foreign Application Priority Data
Nov. 27, 2015 (CN) 201510851606.0

(51) Int. Cl. G06F 11/22; G06F 11/27; G06F 9/44

(52) U.S. Cl. CPC G06F 11/2284; G06F 9/4406; G06F 11/27

(57) ABSTRACT

A method for testing a computer system includes activating an operation system of the computer system and selecting a first selectable number by a basic input/output system interface program. After selecting the first selectable number and rebooting the computer system, if a first enabled number of cores of the computer system is consistent with the first selectable number, but a second selectable number has not been selected, then select the second selectable number by the basic input/output system interface program. After selecting the second selectable number, if a second enabled number of cores of the computer system is consistent with the second selectable number, and no more number is selectable, then determine that the computer system has passed the test.

### BACKGROUND OF THE INVENTION

1. Field of the Invention

This invention relates to a method for testing a computer system, and especially relates to a method for testing a computer system with a basic input/output system interface program.

2. Description of the Prior Art

The success of a product may not only require technical research and design, but also great efforts of testing for ensuring the stability of the product. Especially for high-tech products that require high stability and high reliability, such as industrial instruments, mobile devices, work stations, personal computers or servers, the standard for quality testing is even higher. However, in prior art, the full quality testing may require much of time and human resource. For example, when testing the control of the number of cores in a computer system, one may have to access to the basic input/output system to select the number of cores to be tested first, reboot the computer system to access the operation system to check if the number of cores is correct, reboot the computer system again manually to access to the basic input/output system for selecting the next number of cores to be tested, and reboot the computer system to access the operation system again to check if the next number of cores is correct. This process will be repeated again and again until all different numbers of cores in the computer system are all tested. The great amount of time and human resource required by such kind of process has made the quality testing complicated and difficult.

With the limited time and human resource, many product lines are not able to test all of the products, instead only a small number of the products are tested, resulting in incomplete quality test.

### SUMMARY OF THE INVENTION

One embodiment of the present invention discloses a method for testing a computer system. The method comprises activating an operation system of the computer system, selecting all model-specific functions of the computer system by a basic input/output system interface program in the operation system, rebooting the computer system so as to enable all of the model-specific functions of the computer system and activate the operation system, recording values stored in model-specific registers (MSRs) corresponding to their respective model-specific functions, selecting a first model-specific function of all of the model-specific functions of the computer system by the basic input/output system interface program, and rebooting the computer system so as to disable the first model-specific function and activate the operation system. After the first model-specific function is disabled, if a value stored in a first model-specific register corresponding to the first model-specific function has been updated, but a second model-specific function of the model-specific functions has not been checked, select the second model-specific function by the basic input/output system interface program and reboot the computer system so as to disable the second model-specific function and activate the operation system. After the second model-specific function is disabled, if a value stored in a second model-specific register corresponding to the second model-specific function has been updated, and all of the model-specific functions have been checked, determines that the computer system has passed the test.

Another embodiment of the present invention discloses a method for testing a computer system. The method comprises activating an operation system of the computer system, and selecting a first selectable number by a basic input/output system interface program in the operation system. After selecting the first selectable number, reboot the computer system so as to activate the operation system. After selecting the first selectable number and rebooting the computer system, if a first enabled number of cores of the computer system is consistent with the first selectable number, but a second selectable number has not been selected, select the second selectable number by the basic input/output system interface program. After selecting the second selectable number, reboot the computer system again so as to activate the operation system. After selecting the second selectable number and rebooting the computer system again, if a second enabled number of cores of the computer system is consistent with the second selectable number, and all selectable numbers are checked, determine that the computer system has passed the test.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a computer system according to one embodiment of the present invention.

FIG. 2 shows a flow chart of a method for testing the computer system in FIG. 1.

FIG. 3 shows a computer system according to another embodiment of the present invention.

FIG. 4 shows a flow chart of a method for testing the computer system in FIG. 3.

### DETAILED DESCRIPTION

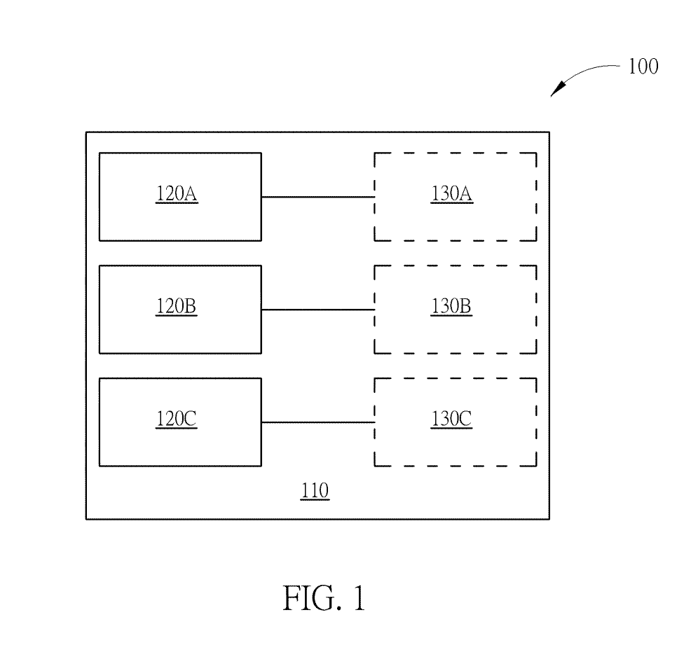

FIG. 1 shows a computer system 100 according to one embodiment of the present invention. The computer system 100 includes a processor 110. The computer system 100 can activate a basic input/output system (BIOS) , an operation system, and a basic input/output system interface program by the processor 110. The basic input/output system interface program can be an interface program provided by manufactures of the basic input/output system. For example, the basic input/output system interface program can be the AMI SCE utility provided by American Megatrends Inc. (AMI). The basic input/output system interface program is compatible with the basic input/output system of the computer system 100. Therefore, by executing the basic input/output system interface program, the computer system 100 is able to modify system parameters after activating the operation system. However, in the past, those system parameters are not allowed for modification in the operation system but only allowed for modification in the basic input/output system.

The processor 110 includes a plurality of model-specific functions, and a user can choose to enable any portion or all of the model-specific functions. For example, the user can choose to enable a cache memory or a buffer memory, and/or the size of the memory to be enabled. The different options provided by the processor 110 are corresponding to different model-specific functions. To know whether the model-specific function has been enabled or disabled normally, the processor 110 can include a plurality of model-specific registers (MSR). In FIG. 1, the processor 110 includes model-specific registers 120A, 120B, and 120C, and the model-specific registers 120A, 120B, and 120C are corresponding to the model-specific functions 130A, 130B, and 130C of the processor 110 respectively.

In some embodiments of the present invention, the values stored in the model-specific registers 120A, 120B, and 120C may represent the status or related information of the model-specific functions 130A, 130B, and 130C, which can be defined by the producer of the processor 110. Therefore, by comparing the definition provided by the producer of the processor 110 with the values stored in the model-specific registers 120A, 120B, and 120C, one can understand the status of the model-specific functions 130A, 130B, and 130C.

In other words, in a normal situation, when the computer system 100 disables the model-specific function 130A, which was enabled previously, or enables the model-specific function 130A, which was disabled previously, the value stored in the model-specific register 120A corresponding to the model-specific function 130A should be changed accordingly. Therefore, by examining whether the value stored in the model-specific register 120A has been changed, the computer system 100 can identify if the model-specific function 130A has been disabled or enabled successfully. Similarly, by examining whether the values stored in the model-specific registers 120B and 120C have been changed, the computer system 100 can identify whether the model-specific functions 130B and 130C have been disabled or enabled successfully.

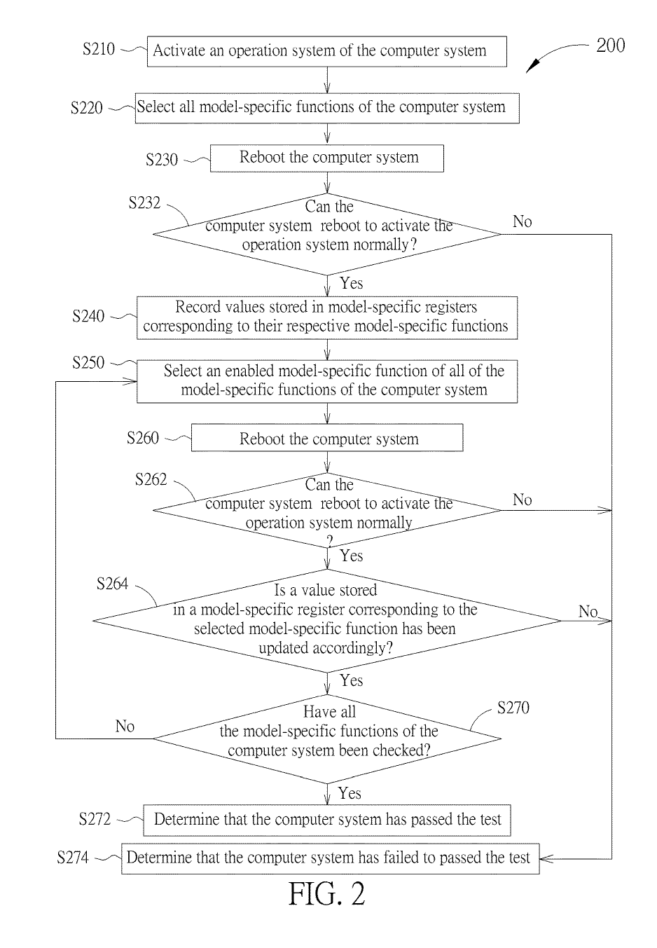

FIG. 2 shows a flow chart of a method 200 for testing the computer system 100. The method 200 includes steps S210 to S274.

S210: activate an operation system of the computer system 100;

S220: in the operation system, select all model-specific functions 130A, 130B, and 130C of the computer system 100 by a basic input/output system interface program;

S230: reboot the computer system 100 so as to enable all of the model-specific functions 130A, 130B, and 130C of the computer system 100 and activate the operation system;

S232: if the computer system 100 can be rebooted to activate the operation system normally, then go to step S240; else go to step S274;

S240: in the operation system, record values stored in model-specific registers 120A, 120B, and 120C corresponding to their respective model-specific functions 130A, 130B, and 130C;

S250: in the operation system, select an enabled model-specific function of all of the model-specific functions 130A, 130B, and 130C of the computer system 100 by the basic input/output system interface program;

S260: reboot the computer system 100 so as to disable the enabled model-specific function selected in the previous step and activate the operation system;

S262: if the computer system 100 can be rebooted to activate the operation system normally, then go to step S264; else go to step S274;

S264: if a value stored in a model-specific register corresponding to the selected model-specific function has been updated, then go to step S270; else go to step S274;

S270: if all model-specific functions of the model-specific functions 130A, 130B, and 130C have been checked, then go to step S272; else go to step S250;

S272: determine that the computer system 100 has passed the test; and

S274: determine that the computer system 100 has failed the test.

The method 200 can test whether the computer system 100 is able to enable and disable each model-specific function normally. For example, when using the method 200 to test the computer system 100, the operation system of the computer system 100 is initially activated in step S210, and all of the model-specific functions 130A, 130B, and 130C of the computer system 100 can be selected in step S220. If the computer system 100 functions normally, then the selected model-specific functions 130A, 130B, and 130C will all be enabled after the rebooting process in step S230. If the computer system 100 fails to be rebooted to activate the operation system successfully, then, in step S232, the test process will move to step S274, which determines that the computer system 100 has failed the test.

In the embodiments of the present invention, before the computer system 100 activates the operation system, the computer system 100 activates the basic input/output system first. In step S220, the basic input/output system interface program of the computer system 100 is compatible with the basic input/output system of the computer system 100. Therefore, by executing the basic input/output system interface program, the computer system 100 can modify the system parameters in the operation system after the operation system is activated.

In step S240, the values stored in the model-specific registers 120A, 120B, and 120C are recorded. Therefore, in the following steps when the model-specific functions 130A, 130B, and 130C are disabled, the updated values stored in the model-specific registers 120A, 120B, and 120C can be compared with the values recorded in step S240 to determine whether the values stored in the model-specific registers 120A, 120B, and 120C have been updated correctly or not.

In step S250, the user can select an enabled model-specific function of all of the model-specific functions 130A, 130B, and 130C by the basic input/output system interface program. For example, the model-specific function 130A may be selected. In this case, to disable the selected model-specific function 130A, the computer system 100 will be rebooted to activate the operation system in step S260. Similarly, if the computer system 100 fails to activate the operation system successfully, then, in step S262, the test process will move to step S274, which determines that the computer system 100 has failed the test. If the computer system 100 is rebooted successfully and the model-specific function 130A is disabled, then in step S264, the value stored in the model-specific register 120A corresponding to the selected model-specific function 130A will be checked to see if it has been updated or not. In other words, after the model-specific function 130A is disabled, the value stored in the model-specific register 120A can be compared with the value stored in the model-specific register 120A in step S240. If the values are different from each other, then one can determine that the value stored in the model-specific register 120A has been updated accordingly. In some embodiments of the present invention, the computer system 100 can further compare the value stored in the model-specific register 120A with the related information defined by the producer of the processor 110 to see if the value is updated correctly. If the value stored in the model-specific register 120A is not updated correctly, then the computer system 100 may not be able to control the model-specific function 130A normally. In this case, one may determine that the computer system 100 has failed the test.

If the value stored in the model-specific register 120A has been updated, then step S270 will further check whether all model-specific functions have been checked. If the model-specific functions 130B and 130C have not been checked yet, the method 200 will repeat steps S250 to S270. In some embodiments of the present invention, the user can sequentially select the model-specific functions 130B and 130C, and to check if the values stored in the model-specific registers 120B and 120C are updated accordingly. After confirming that the computer system 100 can control the model-specific functions 130B and 130C normally, if there is no more model-specific function left unchecked, then in step S270, the test process will move to step S272, which determines that the computer system 100 has passed the test.

According to the method 200, the computer system 100 can select all of the model-specific functions of the computer system 100 in the operation system by the basic input/output system interface program without switching to the basic input/output system during the reboot process manually. Therefore, the computer system 100 can perform steps S210 to S270 according to programs coded in advance so as to test the computer system 100 automatically. In other words, by using the method 200, the difficulty of performing quality test caused by requiring a great amount of time and human resource in prior art can be avoided.

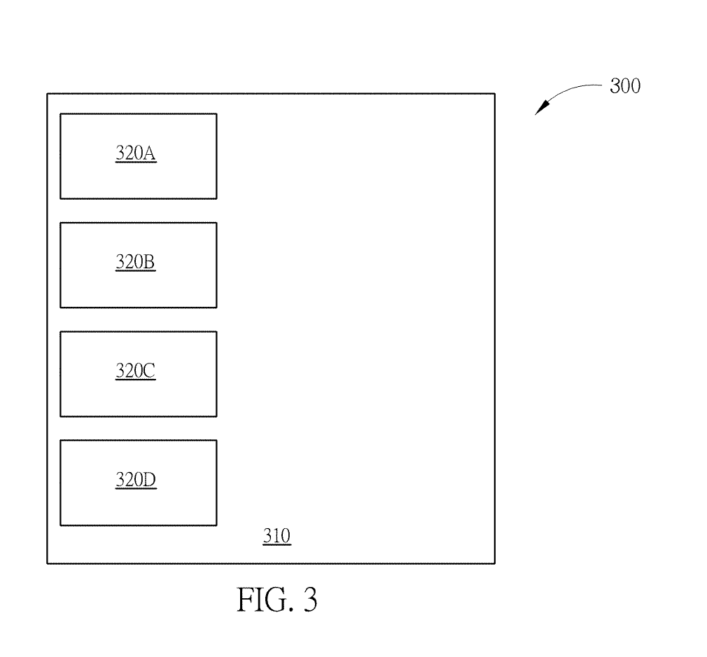

FIG. 3 shows a computer system 300 according to one embodiment of the present invention. The computer system 300 includes a processor 310. The computer system 300 can activate a basic input/output system, an operation system, and a basic input/output system interface program by the processor 310. The basic input/output system interface program can be an interface program provided by the manufacture of the basic input/output system. For example, the basic input/output system interface program can be the AMI SCE utility provided by American Megatrends Inc. (AMI). The basic input/output system interface program is compatible with the basic input/output system of the computer system 300. Therefore, by executing the basic input/output system interface program, the computer system 300 is able to modify system parameters after activating the operation system.

The processor 310 has a plurality of cores 320A, 320B, 320C, and 320D, and a user is allowed to select any number of the cores to be enabled. For example, the user can select to enable only one of the cores 320A, 320B, 320C, and 320D, or to enable three of the cores 320A, 320B, 320C, and 320D. The selectable number for the user should not be greater than the total number of cores 320A, 320B, 320C, and 320D of the processor 310, and should be greater than 0. Therefore, in this embodiment, the selectable numbers for the user are 1 to 4. In a normal situation, after the user selects a selectable number of cores to be enabled and reboots the computer system 300, the number of enabled cores of the processor 310 should be consistent with the selected number and the computer system 300 should still function normally.

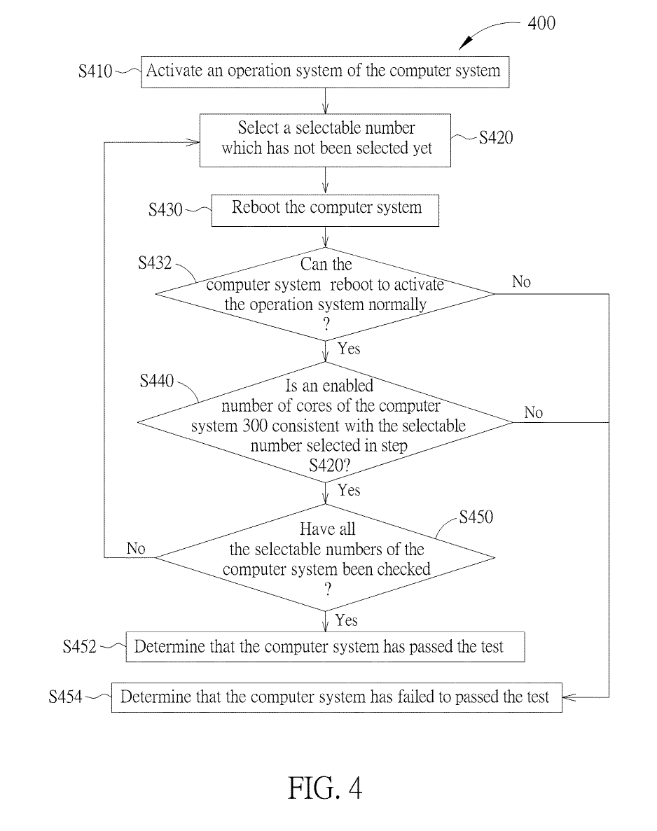

FIG. 4 shows a flow chart of a method 400 for testing the computer system 300. The method 400 can be used for testing the computer system 300 to see if the computer system 300 can function with different number of cores normally. The method 400 includes steps S410 to S454.

S410: activate an operation system of the computer system 300;

S420: in the operation system, select a selectable number, which has not been selected yet, by a basic input/output system interface program;

S430: reboot the computer system 300 so as to activate the operation system;

S432: if the computer system 300 can be rebooted to activate the operation system normally, then go to step S440; else go to step S454;

S440: in the operation system, if an enabled number of cores of the computer system 300 is consistent with the selectable number selected in step S420, then go to step S450; else go to step S454;

S450: if all selectable numbers of the computer system 300 have been checked, then go to step S452; else go to step S420;

S452: determine that the computer system 300 has passed the test; and

S454: determine that the computer system 300 has failed the test.

When using the method 400 to test the computer system 300, the operation system of the computer system 300 is initially activated in step S410, and a selectable number of the computer system 100, which has not been selected, can be selected in step S240 by the basic input/output system interface program. For example, the user may select the selectable number 1 first, which may imply setting the number of cores in the computer system 300 to be enabled to be 1. If the computer system 300 works normally, then the computer system 300 should be able to be rebooted to activate the operation system successfully in step S430. If the computer system 300 fails to be rebooted to the operation system successfully, then, in step S432, the test process will be lead to step S454, which determines that the computer system 300 has failed the test.

In embodiments of the present invention, before the computer system 300 activates the operation system, the computer system 300 activates the basic input/output system first. In step S420, the basic input/output system interface program of the computer system 300 is compatible with the basic input/output system of the computer system 300. Therefore, by executing the basic input/output system interface program, the computer 300 can modify the system parameters in the operation system after the operation system is activated.

In addition, after rebooting, if the computer system 300 works normally, then there will be only one of the cores 320A, 320B, 320C, and 320D of the processor 310 being enabled while the other cores are disabled. Therefore, in step S440, if the enabled number of cores of the computer system 300 is not equal to the selectable number 1 selected in step S420, the process will go to step S454, which determines that the computer system 300 has failed the test. Also, if the enabled number of cores of the computer system 300 is equal to the selectable number 1 selected in step S420, then the process will move to step S450.

In step S450, the method 400 further checks if all of the selectable numbers have been checked or not. If any of the selectable number 2, 3, and 4 has not been checked yet, the method 400 will repeat steps S420 to S450. In some embodiments of the present invention, the user may select the selectable numbers 2, 3, and 4 sequentially, and confirm if the enabled numbers of cores of the computer system 300 are consistent with the selected numbers. After confirming the computer system 300 can function normally with all selectable numbers of cores, that is, no more selectable number of the computer system 300 is left unchecked, the process will move to step S452, which determines that the computer system 300 has passed the test.

According to the method 400, the computer system 300 can select the number of cores of the computer system 300 to be enabled in the operation system by the basic input/output system interface program without switching to the basic input/output system during the reboot process manually. Therefore, the computer system 300 can perform steps S410 to S450 according to programs coded in advance so as to test the computer system 300 automatically. In other words, by using the method 400, the difficulty of quality test caused by requiring a great amount of time and human resource in prior art can be avoided.

In some embodiments of the present invention, when the user selects the number of cores of the processor 310 to be enabled to be 0, the computer system 300 may enable all of the cores of the processor 310 correspondingly by default. Therefore, by selecting the number of cores to be enabled to be 0 and examining the enabled number of cores of the processor 310, one can derive the total number of cores of the processor 310. Therefore, when applying the method 400 to different computer systems, one can execute the aforesaid process to derive the total number of cores in the processor 310 before step S420 so as to ensure that the method 400 can check all selectable numbers of cores of the processor 310.

In addition, in some embodiments of the present invention, the computer system 300 can support a hyper threading (HT) function. That is, each core of the processor 310 has integrated two logic processing units. In other words, if the enabled number of cores appears on the computer system 300 is 4 before the computer system 300 enables the hyper threading function, then the number of enabled cores appears on the computer system 300 will change from 4 to 8 after the hyper threading function is enabled.

For the computer system 300 that supports the hyper threading function, the method 400 can still be applied to test whether the computer system 300 can work normally after enabling the hyper threading function. This can be done by enabling the hyper threading function before step S420, and checking if the enabled number of cores of the computer system 300 is equal to twice the selectable number when determining whether the enabled number of cores of the computer system 300 is consistent with the selectable number in step S440. For example, after the computer system 300 enables the hyper threading function, if the selectable number selected in step S420 is 1, then in the normal situation, the enabled number of cores of the computer system 300 should be twice the selected number 1 in step S440. In other words, in step S440, if the enabled number of cores of the computer system 300 is not equal to 2, then the method 400 will go to step S454, which determines that the computer system 300 has failed the test.

Furthermore, in some embodiments of the present invention, before the computer system 300 enables the hyper threading function, one can perform steps S420 to S450 first to determine whether the computer system 300 is able to pass the test. After confirming that the computer system 300 is able to enable all selectable numbers of cores and function with all selectable numbers of cores normally, one can enable the hyper threading function of the computer system 300 and repeat steps S420 to S450 to determine whether the computer system 300 is able to pass the test with the hyper threading function enabled.

In summary, according to methods provided by the embodiments of the present invention, the computer system can select test options in the operation system by a basic input/output system interface program without switching to the basic input/output system during the reboot process manually. Therefore, the computer system can execute the programs coded in advance for executing steps mentioned in the aforesaid method provided by the embodiments of the present invention so that the computer system can be tested automatically. In other words, the difficulty of quality test caused by requiring a great amount of time and human resource in prior art can be avoided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for testing a computer system, comprising:
activating an operation system of the computer system;
in the operation system, selecting all model-specific functions of the computer system by a basic input/output system interface program;
rebooting the computer system so as to enable all of the model-specific functions of the computer system and activate the operation system;
in the operation system, recording values stored in model-specific registers (MSRs) corresponding to their respective model-specific functions;
in the operation system, selecting a first model-specific function of all of the model-specific functions of the computer system by the basic input/output system interface program;
rebooting the computer system so as to disable the first model-specific function and activate the operation system;
after the first model-specific function is disabled, if a value stored in a first model-specific register corresponding to the first model-specific function has been updated, but a second model-specific function of the model-specific functions has not been checked, selecting the second model-specific function by the basic input/output system interface program;
rebooting the computer system so as to disable the second model-specific function and activate the operation system; and
after the second model-specific function is disabled, if a value stored in a second model-specific register corresponding to the second model-specific function has been updated, and all of the model-specific functions have been checked, determining that the computer system has passed the test.

2. The method for testing the computer system of claim 1, further comprising:
after the first model-specific function is disabled, if the value stored in the first model-specific register corresponding to the first model-specific function has not been updated, determining that the computer system has failed to pass the test; or
after the second model-specific function is disabled, if the value stored in the second model-specific register corresponding to the second model-specific function has not been updated, determining that the computer system has failed the test.

3. The method for testing the computer system of claim 1, further comprising:
determining the value stored in the first model-specific register has been updated if the value stored in the first model-specific register after the first model-specific function is disabled is different from the value stored in the first model-specific register when all of the model-specific functions are enabled; and
determining the value stored in the second model-specific register has been updated if the value stored in the second model-specific register after the second model-specific function is disabled is different from the value stored in the second model-specific register when all of the model-specific functions are enabled.

4. The method for testing the computer system of claim 1, further comprising before activating the operation system of the computer system, activating a basic input/output system of the computer system, wherein the basic input/output system interface program is an interface program compatible with the basic input/output system of the computer system.

5. A method for testing a computer system, the computer system comprising a plurality of cores, and the method comprising:
activating an operation system of the computer system;
in the operation system, selecting a first selectable number by a basic input/output system interface program;
after selecting the first selectable number, rebooting the computer system so as to activate the operation system;
after selecting the first selectable number and rebooting the computer system, if a first enabled number of cores of the computer system is consistent with the first selectable number, but a second selectable number has not been selected, selecting the second selectable number by the basic input/output system interface program;
after selecting the second selectable number, rebooting the computer system again so as to activate the operation system; and
after selecting the second selectable number and rebooting the computer system again, if a second enabled number of cores of the computer system is consistent with the second selectable number, and all selectable numbers are checked, determining that the computer system has passed the test.

6. The method for testing the computer system of claim 5, further comprising:
determining the first enabled number of cores of the computer system is consistent with the first selectable number if the first enabled number of cores of the computer system is equal to the first selectable number; and
determining the second enabled number of cores of the computer system is consistent with the second selectable number if the second enabled number of cores of the computer system is equal to the second selectable number.

7. The method for testing the computer system of claim 6, further comprising:
after selecting the first selectable number and rebooting the computer system, if the first enabled number of cores of the computer system is different from the first selectable number, determining that the computer system has failed the test; or
after selecting the second selectable number and rebooting the computer system again, if the second enabled number of cores of the computer system is different from the second selectable number, determining that the computer system has failed the test.

8. The method for testing the computer system of claim 5, further comprising:
before selecting the first selectable number, enabling a hyper threading function of the computer system;
determining the first enabled number of cores of the computer system is consistent with the first selectable number if the first enabled number of cores of the computer system is equal to twice the first selectable number; and
determining the second enabled number of cores of the computer system is consistent with the second selectable number if the second enabled number of cores of the computer system is equal to twice the second selectable number.

9. The method for testing the computer system of claim 8, further comprising:
after selecting the first selectable number and rebooting the computer system, if the first enabled number of cores of the computer system is different from twice the first selectable number, determining that the computer system has failed the test; or
after selecting the second selectable number and rebooting the computer system again, if the second enabled number of cores of the computer system is different from twice the second selectable number, determining that the computer system has failed the test.

10. The method for testing the computer system of claim 5, further comprising before activating the operation system of the computer system, activating a basic input/output system of the computer system, wherein the basic input/output system interface program is an interface program compatible with the basic input/output system of the computer system.
